(19) United States
(12) Patent Application Publication
(10) Pub. No.: US 2014/0067758 A1
(43) Pub. Date: Mar. 6, 2014

(54) METHOD AND APPARATUS FOR PROVIDING EDGE-BASED INTEROPERABILITY FOR DATA AND COMPUTATIONS

(71) Applicants: Sergey Boldyrev, Soderkulla (FI); Dmitry Kolesnikov, Vantaa (FI)

(72) Inventors: Sergey Boldyrev, Soderkulla (FI); Dmitry Kolesnikov, Vantaa (FI)

(73) Assignee: Nokia Corporation, Espoo (FI)

(21) Appl. No.: 13/596,656

(22) Filed: Aug. 28, 2012

(51) Int. Cl. G06F 17/30

(52) U.S. Cl. 707/610; 707/736; 707/E17.005; 707/769; 707/E17.014; 707/E17.032

(57) ABSTRACT

An approach is described for providing edge-based interoperability of data and computations. An edge computing platform causes, at least in part, a colocation one or more data records with one or more computations as one or more computation closures. The one or more computations are for processing the one the one or more data records. The edge computing platform also causes, at least in part, a storage of the one or more computation closures at one or more nodes of at least one cloud computing architecture for servicing one or more queries. The one or more nodes include, at least in part, one or more edge nodes, one or more regional nodes, one or more core nodes, or a combination thereof.

### BACKGROUND

Today's Internet ready wireless communication devices such as mobile phones, personal data assistants (PDAs), laptop computers and the like, make on-demand access to information convenient for users. As the demand for data grows, so does the need for effective management and processing of data of various types, especially in distributed or cloud based networking environments where multiple communication devices may interact to share, collect and analyze information across different services and/or domains. However, as the number of different service providers and/or domains associated with providing cloud based services increase, issues of data compatibility, service responsiveness, resource load, etc. across service or domain boundaries or edges pose significant technical challenges to service providers and device manufacturers (e.g., wireless, cellular, etc.).

### Some Example Embodiments

Therefore, there is a need for an approach for providing an efficient architecture for edge-based interoperability for data and computations in a cloud computing environment.

According to one embodiment, a method comprises causing, at least in part, a colocation one or more data records with one or more computations as one or more computation closures. The one or more computations are for processing the one the one or more data records. The method also comprises causing, at least in part, a storage of the one or more computation closures at one or more nodes of at least one cloud computing architecture for servicing one or more queries. The one or more nodes include, at least in part, one or more edge nodes, one or more regional nodes, one or more core nodes, or a combination thereof.

According to another embodiment, an apparatus comprises at least one processor, and at least one memory including computer program code for one or more computer programs, the at least one memory and the computer program code configured to, with the at least one processor, cause, at least in part, the apparatus to colocate one or more data records with one or more computations as one or more computation closures. The one or more computations are for processing the one the one or more data records. The apparatus is also caused to store the one or more computation closures at one or more nodes of at least one cloud computing architecture for servicing one or more queries. The one or more nodes include, at least in part, one or more edge nodes, one or more regional nodes, one or more core nodes, or a combination thereof.

According to another embodiment, a computer-readable storage medium carries one or more sequences of one or more instructions which, when executed by one or more processors, cause, at least in part, an apparatus to colocate one or more data records with one or more computations as one or more computation closures. The one or more computations are for processing the one the one or more data records. The apparatus is also caused to store the one or more computation closures at one or more nodes of at least one cloud computing architecture for servicing one or more queries. The one or more nodes include, at least in part, one or more edge nodes, one or more regional nodes, one or more core nodes, or a combination thereof.

According to another embodiment, an apparatus comprises means for causing, at least in part, a colocation one or more data records with one or more computations as one or more computation closures. The one or more computations are for processing the one the one or more data records. The apparatus also comprises means for causing, at least in part, a storage of the one or more computation closures at one or more nodes of at least one cloud computing architecture for servicing one or more queries. The one or more nodes include, at least in part, one or more edge nodes, one or more regional nodes, one or more core nodes, or a combination thereof.

In addition, for various example embodiments of the invention, the following is applicable: a method comprising facilitating a processing of and/or processing (1) data and/or (2) information and/or (3) at least one signal, the (1) data and/or (2) information and/or (3) at least one signal based, at least in part, on (or derived at least in part from) any one or any combination of methods (or processes) disclosed in this application as relevant to any embodiment of the invention.

For various example embodiments of the invention, the following is also applicable: a method comprising facilitating access to at least one interface configured to allow access to at least one service, the at least one service configured to perform any one or any combination of network or service provider methods (or processes) disclosed in this application.

For various example embodiments of the invention, the following is also applicable: a method comprising facilitating creating and/or facilitating modifying (1) at least one device user interface element and/or (2) at least one device user interface functionality, the (1) at least one device user interface element and/or (2) at least one device user interface functionality based, at least in part, on data and/or information resulting from one or any combination of methods or processes disclosed in this application as relevant to any embodiment of the invention, and/or at least one signal resulting from one or any combination of methods (or processes) disclosed in this application as relevant to any embodiment of the invention.

For various example embodiments of the invention, the following is also applicable: a method comprising creating and/or modifying (1) at least one device user interface element and/or (2) at least one device user interface functionality, the (1) at least one device user interface element and/or (2) at least one device user interface functionality based at least in part on data and/or information resulting from one or any combination of methods (or processes) disclosed in this application as relevant to any embodiment of the invention, and/or at least one signal resulting from one or any combination of methods (or processes) disclosed in this application as relevant to any embodiment of the invention.

In various example embodiments, the methods (or processes) can be accomplished on the service provider side or on the mobile device side or in any shared way between service provider and mobile device with actions being performed on both sides.

For various example embodiments, the following is applicable: An apparatus comprising means for performing the method of any of originally filed claims 1-10, 21-30, and 46-48.

Still other aspects, features, and advantages of the invention are readily apparent from the following detailed description, simply by illustrating a number of particular embodiments and implementations, including the best mode contemplated for carrying out the invention. The invention is also capable of other and different embodiments, and its several details can be modified in various obvious respects, all without departing from the spirit and scope of the invention. Accordingly, the drawings and description are to be regarded as illustrative in nature, and not as restrictive.

### BRIEF DESCRIPTION OF THE DRAWINGS

The embodiments of the invention are illustrated by way of example, and not by way of limitation, in the figures of the accompanying drawings:

FIG. 1A is a diagram of a system capable of providing an architecture for providing edge-based interoperability for data and computations, according to one embodiment;

FIG. 1B is a diagram of layered cloud computing architecture for providing edge-based interoperability for data and computations, according to one embodiment;

FIG. 1C is a diagram of the nodes of cloud computing architecture for providing edge-based interoperability for data and computations, according to one embodiment;

FIG. 1D is a diagram depicting example of providing edge-based interoperability for data and computations, according to one embodiment;

FIG. 2 is a diagram of the components of an edge computing platform, according to one embodiment;

FIG. 3 is a flowchart of a process for providing computation closures to enable edge-based interoperability of data and computations, according to one embodiment;

FIG. 4 is a flowchart of a process for determining the exposure query results generated using edge-based interoperability for data and computations, according to one embodiment;

FIG. 5 is a flowchart of a process for migrating computation closures within a cloud computing architecture to facilitate edge-based interoperability of data and computations, according to one embodiment;

FIG. 6 is a diagram of a decomposition of service queries for edge-based interoperability of data and computations, according to one embodiment;

FIG. 7 is a diagram of a data application programming interface for providing edge-based interoperability of data and computations, according to one embodiment;

FIG. 8 is a diagram of hardware that can be used to implement an embodiment of the invention;

FIG. 9 is a diagram of a chip set that can be used to implement an embodiment of the invention; and

FIG. 10 is a diagram of a mobile terminal (e.g., handset) that can be used to implement an embodiment of the invention.

### DESCRIPTION OF SOME EMBODIMENTS

Examples of a method, apparatus, and computer program for providing edge-based interoperability of data and computations are disclosed. In the following description, for the purposes of explanation, numerous specific details are set forth in order to provide a thorough understanding of the embodiments of the invention. It is apparent, however, to one skilled in the art that the embodiments of the invention may be practiced without these specific details or with an equivalent arrangement. In other instances, well-known structures and devices are shown in block diagram form in order to avoid unnecessarily obscuring the embodiments of the invention.

Although various embodiments are described with respect to reflective or granular process computing, it is contemplated that the approach described herein may be used with other computation systems and architectures as well. This includes information space architectures, smart space architectures, cloud-based computing architectures, or combinations thereof. An information space, smart space or cloud may include, for example, any computing environment for enabling the sharing of aggregated data items and computation closures from different sources among one or more nodes. This multi-sourcing is very flexible since it accounts and relies on the observation that the same piece of information can come from different sources. For example, the same information (e.g., image data) can appear in the same information space from multiple sources (e.g., a locally stored contacts database, a social networking directory, etc.). In one embodiment, information and computations of data within the information space, smart space or cloud is represented using Semantic Web standards such as Resource Description Framework (RDF), RDF Schema (RDFS), OWL (Web Ontology Language), FOAF (Friend of a Friend ontology), rule sets in RuleML (Rule Markup Language), etc. Furthermore, as used herein, RDF refers to a family of World Wide Web Consortium (W3C) specifications originally designed as a metadata data model. It represents a general method for conceptual description or modeling of information that is implemented in web resources; using a variety of syntax formats.

Computation closures, by way of example, may include any data computation procedure together with relations and communications among interacting nodes within the information space, smart space, cloud or combination thereof, for passing arguments, sharing process results, selecting results provided from computation of alternative inputs, flow of data and process results, etc. The computation closures (e.g., a granular reflective set of instructions, data, and/or related execution context or state) provide the capability of slicing of computations for processes and transmitting the computation slices between nodes, infrastructures and data sources. Also, reflective computing may include, for example, any capabilities, features or procedures by which the smart space, information space, cloud or combination thereof permits interacting nodes to reflect upon their behavior as they interact and actively adapt. Reflection enables both inspection and adaptation of systems (e.g., nodes) and processed at run time. While inspection allows the current state of the system to be observed, adaptation allows the system's behavior to be altered at run time to better meet the processing needs at the time.

Typically, reflective computing is a convenient means to enable adaptive processing to be performed respective to the contextual, environment, functional or semantic conditions present within the system at the moment. Furthermore, it is particularly useful for systems destined for operation within a distributed computing environment (e.g., cloud based environment) for executing computations. In one embodiment, the cloud provides access to distributed computations for various services (e.g., when service providers contract for services or functions—such as mapping or location services—for use their own services). For example, a search provider may rely on location services from another service provider to enable location-based results; a social networking provider may contract for media content services from another provider; and the like. Such combined or integrated services can result in the need for service interoperability that can cross the boundaries or edges of the domains associated with each service.

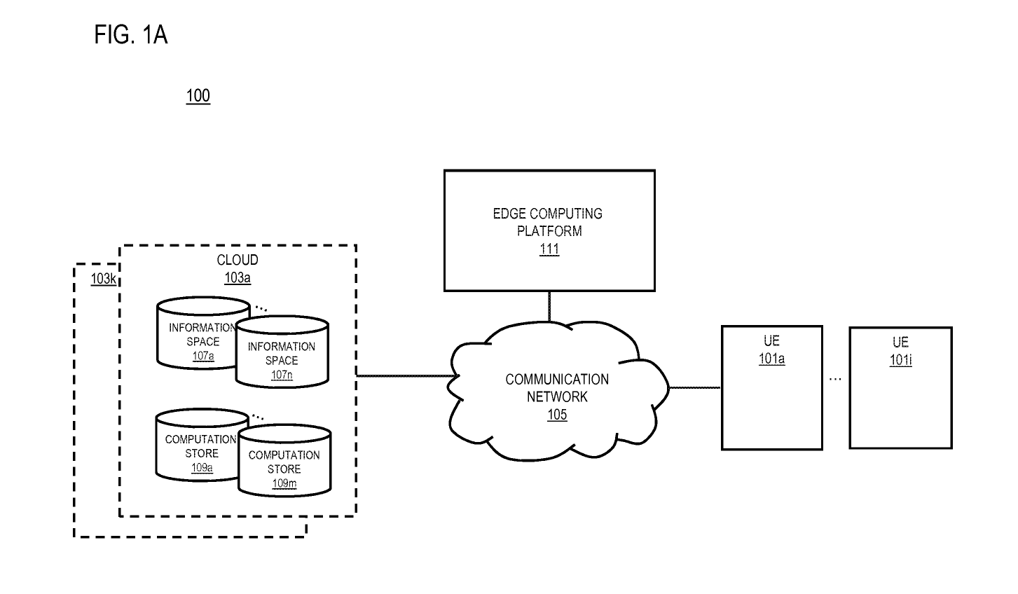

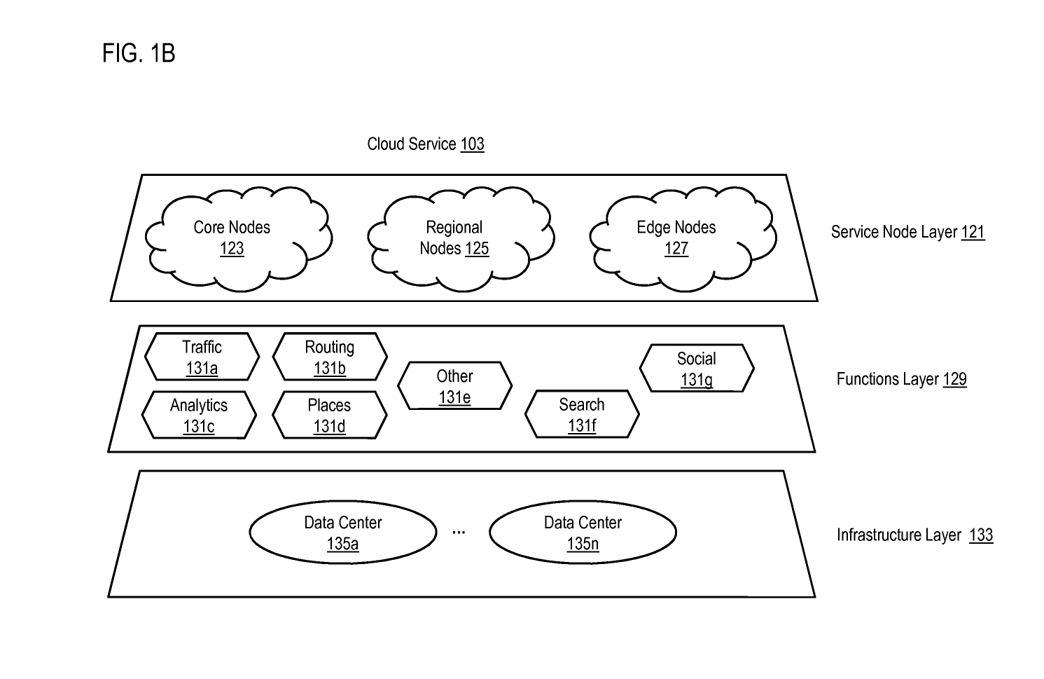

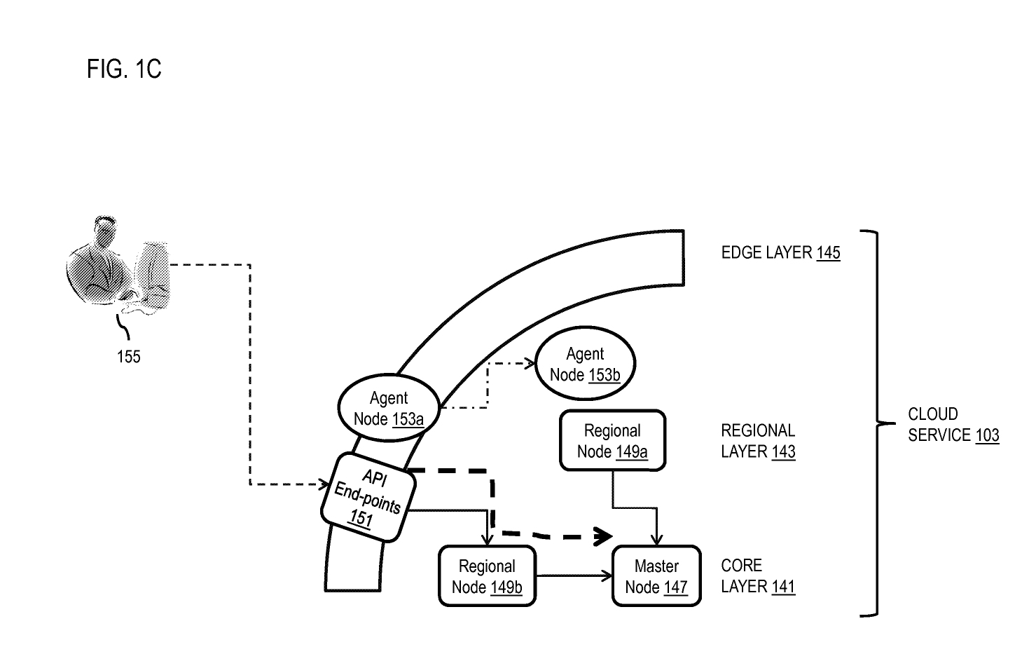

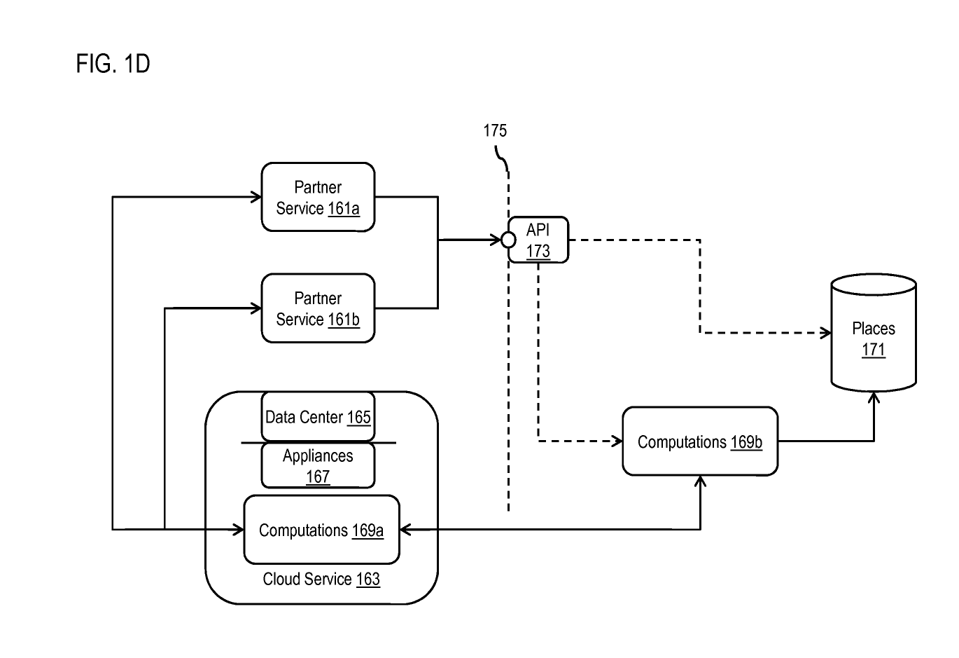

FIG. 1A is a diagram of a system capable of providing an architecture for providing edge-based interoperability for data and computations, according to one embodiment. For the purpose of example, the system 100 is presented from the perspective of a distributed computing environment, wherein one or more user equipment (UEs) 101a-101n (also collectively referred to as UEs 101) may interact with various cloud services 103a-103k (also collectively referred to as cloud services 103) over a communication network 105. In one embodiment, the cloud services include one or more information spaces 107a-107n (also collectively referred to as information spaces 107) and one or more computation stores 109a-109m (also collectively referred to as computation stores 109) comprising associated with providing the cloud services 103.

In one embodiment, the information spaces 107 and computation stores 109 store the data and computations (e.g., as computation closures) that provide the functions of the cloud services 103. By way of example, the system 100 is enables a serialization of one or more computations for processing of data associated with the cloud services 113. In one embodiment, the serialized computations are then stored in the information spaces 107 and/or the computation stores 109 for subsequent use. As such, when a UE 101 or other node of the cloud services 103—i.e., a physical, virtual or software device operating within the distributed environment—attempts to query, collect, store, retrieve, or otherwise use the data items, an associated serialization of the one or more computations (e.g., a computation closure) is executed as well.

In one embodiment, the data items may be accessed from multiple cloud services 113 and span different domains associated with those cloud services and/or their underlying infrastructure. As previously discussed, when data items or queries, functions, computations, etc. that use those data items cross edges or boundaries of the domains of the cloud architecture, there is a potential a degradation in response time, service availability, or other network latency issues.

By way of example, FIG. 1B is a diagram of layered cloud computing architecture for providing edge-based interoperability for data and computations, according to one embodiment. As shown in FIG. 1B, a cloud service 103 can consists of various components at different conceptual layers. For example, the cloud service 103 can be described at a service node layer 121 that include core nodes 123, regional nodes 125, and edge nodes 127. In this example, the nodes represent interaction points (e.g., physical or virtual computing nodes responsible for providing the cloud service 123). In one embodiment, core nodes 123 are most proximately controlled and updated by a service provider of the cloud service 103. Then the regional nodes 125 are further away from the service provider and closer to the end user (e.g., UEs 101). Typically, regional nodes 125 can be part of a content delivery network that scales the capabilities or services of the core nodes 123 to support greater numbers of users, different geographic areas, and the like. Next are the edge nodes 127 are the nodes closest to the end users and/or other interfacing services. For example, edge nodes 127 are typically distributed to provide or enable direct interaction with end users. These can also be considered the front-end servers that provide access points or interfaces to the cloud service 103. It is noted that although only three levels of nodes are discussed in this example, it is contemplated that the nodes of the cloud service 103 may be organized into any number of node categories and not just core nodes 123, regional nodes 125, and edge nodes 127.

Based on this architecture, service providers generally configure the core nodes 123 with a complete set of service data, computations, and functions and then replicate only the portion of the data, computations, and functions that relate to each subsequent class of nodes. For example, for location based cloud service 103, the core nodes 123 may include a global set of map tiles (e.g., including the data and computations associated with generating those map tiles), while the regional nodes 125 may only include a subset of the data that applies to the particular geographical regional of each regional node 125. Then the regional nodes 125 may provide a further subset of the information to each associated edge node 125. Under this scenario, service availability and/or latency issues may arise if queries for information at a distant node (e.g., an edge node) are for information that crosses domains or need further information from a lower level node.

This problem is also evident at the next conceptual layer (e.g., the functions layer 129) of the cloud service 103. At the functions layer 129, the cloud service 103 is not viewed from the perspective of the nodes 123-127, but from what functions are available from the cloud service 103. For example, in the context of a location cloud service, these can include a traffic function 131a, a routing function 131b, an analytics function 131c, a places function 131d, an other function 131e, a search function 131f, and a social function 131g (also collectively referred to as functions 131). In some embodiments, these functions 131 may require different levels of cross domain or edge-based interoperability. For example, native functions such as the traffic function 131a or the routing function 131b may be performed without reference to cross domain data, whereas other functions such as the social function 131g or the search function 131f may require access to data or computations from a search domain or a social domain. In addition, when the functions are overlaid on the node structure of the service node layer 121, different functions may be best performed by different node classes. For example, the analytics function 131c might be more appropriate for the core nodes 123 because a comprehensive data set is needed. Accordingly, at the functions layer 129, data and computation migration may still be needed, thereby introducing the potential avenues for developing issues with response time, latency, availability, etc.

Finally, at the infrastructure layer 133, the cloud service 103 can be mapped to physical data centers 135a-135n (also collectively referred to as data centers 135) or other hardware components (e.g., routers, data clusters, switches, etc.) that comprise the physical infrastructure that supports the cloud service 103. In some embodiments, the nodes 123-127 of the service node layer 121 correspond to each physical data center 135. In other embodiments, the nodes 123-127 may correspond to virtual nodes of the physical data centers 135. For example, in a distributed architecture such as information spaces 107 and/or computation stores 109, the nodes 123-127 may correlate to different portions of different physical data centers 135 or other components of the infrastructure. Accordingly, as data, computations, or functions of the cloud service 103 are accessed at different conceptual layers, the physical data centers 135 may have to exchange or replicate the under data and computations from one physical data center 135 to the next. These data exchanges or transfers can introduce availability and latency problems particularly when the physical data centers are located a vastly different physical locations or belong to different domains. For example, the physical data centers 135 of a cloud service 103 may belong to different domains (e.g., a search provider, a location services provider, a media provider, etc.) if the cloud service 103 is a combination or aggregate of different underlying services.

In other words, at any conceptual layer of the cloud service 103, when tasks span across the edges or boundaries (e.g., when moving service data to the edge nodes 127 to service end users), there is a potential for causing issues with service response times, availability, and network latency.

To address at least these problems, the system 100 introduces a capability to extend a data-oriented edge platform (e.g., the edge computing platform 111 of FIG. 1A) into distributed systems which can seamlessly span data and computations (e.g., computation closures) around the edge and cloud infrastructures (e.g., between boundaries of different domains). In one embodiment, the system 100 provides an integrated experience for service providers via a well-defined entry point and set of application programming interfaces (APIs) to enable access to edge-based interoperability. In embodiments where the data and computations are serialized as computation closures, the system 100 enables access to granular processing and data in the cloud infrastructure, thereby enabling a broader more dynamic array of cloud services 103.

More specifically, the system 100 (e.g., the via edge computing platform 111) enables a colocation of data and computations to be stored and cached at different levels of a cloud computing architecture. In one embodiment, the data and computations are serialized as computation closures which are data objects that can contain both data and the computations for processing the data. Because computation closures are data objects, they can be transported within distributed systems as data is transported within the distributed system, thereby facilitating easy migration and reflectivity of the computation closures based on the computational environment.

In one embodiment, the system 100 migrates and/or prioritizes the migration of the computation closures, data, or computations of cloud services 103 to edge nodes 107 to facilitate load balancing and avoiding latency issues that may arise if computation closures are needed from lower level nodes such as the regional nodes 125 or the core nodes 123. Because, the edge nodes 127 are typically more proximate to end users (e.g., consumers as well as other services) than the regional nodes 125 or the core nodes 123. Moreover, because the data and computations are colocated and transported within the system 100 as a unit, the system 100 provides for greater processing granularity and the ability to combine or reuse the computation closures for different tasks or processes. When migrating or spawning computation closures across domains, the spawned or migrated computation closure may provide new functionality to a cloud service 103 that receives the spawned or migrated computation closure.

In one embodiment, the system 100 can enforce policies (e.g., privacy policies, security policies, etc.) that can affect the exposure of data across different domains or edges. For example, a cloud service 103 (e.g., a mapping service that wants to overlay information on a map) may need to access information (e.g., information to overlay on a map) from difference sources available at different nodes 123-127 of the cloud service 103 or from different domains. By way the information needed can be specified via a query that crosses domain boundaries or edges. The parties controlling the sources or nodes 123-127 may wish to not expose raw data to each other, only the results of the computation acting on data are to be shared (e.g., the rendered and assembled map vs. the raw information to overlay on the map). In this case, the edge computing platform 111 enables the cloud service 103 to spawn computation processes (e.g., computation closures) at the different nodes 123-127 of the parties associated with the data to be processed. The edge computing platform 111 can migrate the computations and results of such computations to edge nodes 127 belonging to the cloud services 103 sharing the information. Then when the results are needed, the edge computing platform 113 can migrate the computations from the edge nodes 127 to the nodes 123-127 of the customer cloud service 103.

In one embodiment, if the results of the computations are frequently requested or popular (e.g., map tiles of frequently traveled locations), the edge computing platform 111 may pre-cache all or a portion of the results, data, computations, computation closures, etc. associated with the frequent or popular results. In one embodiment, the amount and types of information to cache can depend on parameters such as data update frequency, request frequency, granularity of the data (e.g., zoom level of map tiles), geographic regions, time of day, resource load at the caching node, resource availability at the caching node, and/or any other contextual parameter.

Although various embodiments are discussed with respect to edge-based interoperability via distributed systems, it is contemplated that the various embodiments described herein are also applicable to other interoperability frameworks. For example, the approach of the various embodiments described herein is applicable to systems at an Infrastructure-as-a-Service (IaaS) or a Platform-as-a-Service (PaaS) layer as defined by the National Institute of Standards and Technology (NIST). By way of example, IaaS includes all the system services that make up the foundation layer of a cloud—the server, computing, operating system, storage, data back-up and networking services. Operating at this layer, the system 100 can manage the networking, hard drives, hardware of the server, virtualization O/S (if the server is virtualized) to provide edge-based interoperability. PaaS includes the development tools to build, modify and deploy cloud optimized applications. Operating at this layer, the infrastructure 117 provides hosted application/framework/tools for building cloud optimized applications. In one embodiment, the system 100 enables the computation closures or other computation components to configure the PaaS from core, cloud, and/or edge perspectives. Interoperability via IaaS and/or PaaS can also be determined based on performance, scalability, energy consumption, resource available, resource load, etc.

In another embodiment, the system 100 may enable access to functions related to edge-based interoperability via standardized application programming interfaces (e.g., Open Data Protocol (OData) application programming interfaces). In one embodiment, data and computation resources are exposed via collection of RESTful end-points that forms the application programming interface (API) portfolio that are sharable with partnering services to facilitate edge-based interoperability according to the various embodiments described herein.

In one embodiment, the utilization of OData or other similar standard for data and computation interoperability enables cloud-to-cloud integration to provide for combined services. The standard also enables client-to-cloud integration whereby client data streams (e.g., either collected from or transmitted to) can cross domain edges and boundaries to enable a greater range of services. By way of example, OData exposes a _Service_ via _Collections_ of typified data _Entities_. In this example, Each _Entity_{—} is composed of a data, meta-data and cross-entity associations. In addition, OData exposes _Collection_ which defines a _Service Operations_ that represents computation procedures applicable to data entities over the communication network 105.

By way of example, the communication network 105 of system 100 includes one or more networks such as a data network, a wireless network, a telephony network, or any combination thereof. It is contemplated that the data network may be any local area network (LAN), metropolitan area network (MAN), wide area network (WAN), a public data network (e.g., the Internet), short range wireless network, close proximity network, or any other suitable packet-switched network, such as a commercially owned, proprietary packet-switched network, e.g., a proprietary cable or fiber-optic network, and the like, or any combination thereof. In addition, the wireless network may be, for example, a cellular network and may employ various technologies including enhanced data rates for global evolution (EDGE), general packet radio service (GPRS), global system for mobile communications (GSM), Internet protocol multimedia subsystem (IMS), universal mobile telecommunications system (UMTS), etc., as well as any other suitable wireless medium, e.g., worldwide interoperability for microwave access (WiMAX), Long Term Evolution (LTE) networks, code division multiple access (CDMA), wideband code division multiple access (WCDMA), wireless fidelity (WiFi), wireless LAN (WLAN), Bluetooth®, Internet Protocol (IP) data casting, satellite, mobile ad-hoc network (MANET), and the like, or any combination thereof.

The UEs 101 are any type of mobile terminal, fixed terminal, or portable terminal including a mobile handset, station, unit, device, multimedia computer, multimedia tablet, Internet node, communicator, desktop computer, laptop computer, notebook computer, netbook computer, tablet computer, personal communication system (PCS) device, personal navigation device, personal digital assistants (PDAs), audio/video player, digital camera/camcorder, positioning device, television receiver, radio broadcast receiver, electronic book device, game device, or any combination thereof, including the accessories and peripherals of these devices, or any combination thereof. It is also contemplated that the UEs 101 can support any type of interface to the user (such as “wearable” circuitry, etc.).

By way of example, the UEs 101, the cloud services 103, the edge computing platform 111 communicate with each other and other components of the communication network 105 using well known, new or still developing protocols. In this context, a protocol includes a set of rules defining how the network nodes within the communication network 105 interact with each other based on information sent over the communication links. The protocols are effective at different layers of operation within each node, from generating and receiving physical signals of various types, to selecting a link for transferring those signals, to the format of information indicated by those signals, to identifying which software application executing on a computer system sends or receives the information. The conceptually different layers of protocols for exchanging information over a network are described in the Open Systems Interconnection (OSI) Reference Model.

Communications between the network nodes are typically effected by exchanging discrete packets of data. Each packet typically comprises (1) header information associated with a particular protocol, and (2) payload information that follows the header information and contains information that may be processed independently of that particular protocol. In some protocols, the packet includes (3) trailer information following the payload and indicating the end of the payload information. The header includes information such as the source of the packet, its destination, the length of the payload, and other properties used by the protocol. Often, the data in the payload for the particular protocol includes a header and payload for a different protocol associated with a different, higher layer of the OSI Reference Model. The header for a particular protocol typically indicates a type for the next protocol contained in its payload. The higher layer protocol is said to be encapsulated in the lower layer protocol. The headers included in a packet traversing multiple heterogeneous networks, such as the Internet, typically include a physical (layer 1) header, a data-link (layer 2) header, an internetwork (layer 3) header and a transport (layer 4) header, and various application (layer 5, layer 6 and layer 7) headers as defined by the OSI Reference Model.

FIG. 1C is a diagram of the nodes of cloud computing architecture for providing edge-based interoperability for data and computations, according to one embodiment. As shown in FIG. 1C, the computing architecture for a cloud service 103 consists of three architectural layers, a core layer 141, a regional layer 143, and an edge layer 145. The core layer 141 hosts the components that originate a particular cloud application or service and includes a master node 147 (e.g., performs the functions of a core node 123). For example, with respect to a location-based cloud service, the core layer 141 may host core location services such as: (1) providing map tiles, including 2D, 3D, satellite, hybrid, and terrain; (2) providing routing and navigation; (3) geocoding and reverse geocoding; (4) providing traffic overlays; (5) providing dynamic map rendering; and the like. In the location examples, each of the services or functions can be data and computation intensive with specific data, computations, and/or computation closures devote to each task. In one embodiment, all or a portion of the tasks can be outsourced to the regional layer 143 and/or edge layer 145 described below.

The regional layer 143 provides replication and workload distribution of the functions of the core layer 141 using regional nodes 149a and 149b, and the edge layer 145 hosts data end points that interface with client devices (e.g., UEs 101) via the API end points 151 and/or agent nodes 153a-153b (e.g., performs the functions of edge nodes 127). In one embodiment, service level APIs 151 and/or agent nodes 153a-153b are outsourced from the core layer 141 to the regional layer 143 and beyond to the edge layer 145. Each of the layers are considered contributing nodes of the overall cloud service 103 that include components that can be provisioned to provide a particular cloud application or service (e.g., a location application). In cases where, the service uses information crosses domain edges or boundaries, the APIs 151 and/or agent nodes 153a-153b provide a means for spawning or migrating the data and computations from the nodes of one domain to the nodes of another domain. By way of example, the API end points 151 (e.g., OData end points or equivalent) can deployed on the edge layer 145 and within the cloud service 103 to facilitate edge-based interoperability.

In one embodiment, the system 100 leverages the computational load associated with the cloud service 103 among the various layers through the data and computations serialized as data or digital objects (e.g., computation closures). In one example, these digital objects, for instance, include location-based data such as map tiles, augmented reality tiles, as well as connectivity information (e.g., CR resources). These digital objects include the computation closures for processing and/or other managing the data contained therein. In this way, functions such as regional databases, coexistence managers for determining connectivity options, etc. can be outsourced from the core layer 141 to the regional layer 143 and/or the edge layer 145. Thus, in one example, the computational workload associated with the cloud service 103 can be intelligently moved by taking specific service features into account. For example, for location-based services, feature specified to functions such as mapping, navigation, augmented reality (AR), etc. may be taken into account (e.g., resolution, level of detail, and other performance critical attributes). In this way, the system 100 increases the computational elasticity of mixed reality applications by enabling migration of both data and computations from one architectural layer to another.

In one embodiment, the approach for granular digital object composition and decomposition is defined as a function of the capabilities of the end device, congestion of the data/computational point on the edge layer 145 (e.g., latency bucket) and the computational/data support of the back-end (e.g., core layer 141 and/or regional layer 143). In one embodiment, the support consists of:
(1) constructing mesh granularity to identity more and less dynamic computations;
(2) supporting computation or digital object migration from the core 121 to the edge 125 or beyond the edge to another domain;
(3) pre-fetching or caching of regional data structures and computations; and
(4) identifying what endpoints are used and how frequently their contents are updated based on, for instance, monitoring requests from user devices received at the end points.

In one embodiment, computational activities are partially executed at different layers of the cloud service 103 or domains associated with the service 103. Under this scenario, one set of these data and/or computation components (e.g., map tiles, AR tiles, etc.) could form one specific computational activity domain. When the results of the computations are available, the system 100 can migrate the domain-specific results to the edge nodes of the respective nodes. Then, the results and/or associated data, computations, computation closures, etc. can be migrated or spawned across the domain boundary or edge when the results are needed in the other domain.

In one embodiment, the end user device 155 interacts with the cloud service 103 via the API end-points 151 and/or the agent nodes 153a-153b. For example, the end user device 155 can be a client device that provides a stream of data to the cloud service 103 for processing by at one or more layers 141-145 that can potentially span multiple domains. For example, the data stream may be used by the cloud service 103 to construct one or more data sets including, for instance, (1) a referential data set, (2) a crowd sourced data set, (3) a social data set, (4) a personal data set, (5) a behavioral data set, or (6) a combination thereof. In one embodiment, the edge-based interoperability of the various embodiments described herein enables bidirectional penetration of between the edges of underlying data centers 135, domains, and/or cloud services 103. For example, data extraction

FIG. 1D is a diagram depicting example of providing edge-based interoperability for data and computations, according to one embodiment. The example of FIG. 1D illustrates a sample use case in which two partner services 161a-161b (e.g., first party or third party services) that have contracted with a cloud service 163 for a mapping function. In this example, the partner services 161a-161b and the cloud service 163 are in different domains. To initiate the partnership, the data center 165 of the cloud service 163 has provided access to the computations 169a for delivering the mapping function.

In one embodiment, when the partner services 161a-161b want to access the mapping function, the partners 161a-161b may initiate a request or a query for the function/results and transmit request directly to cloud service. The data center 165 and/or the appliances 167 (e.g., network infrastructure appliances) of the cloud service 163 may then respond to the request or query using the computations 169a. In another embodiment, the cloud service 163 may migrate the computations 169a to the partner services 161a-161b to for execution so that the partner services 161a-161b may determine the results directly.

In one embodiment, the partner services 161a-161b may have to access data (e.g., places 171) to service the request or query. However, this data may be in the cloud service 163's domain, and the cloud service 163 may not want to expose the entire raw data set stored in places 171. In this embodiment, the partner services 161a-161b may direct its request or query to the API end point 173 at the boundary 175 between the respective domains of the partner services 161a-161b and the cloud service 163. In one embodiment, the cloud service 163 (e.g., via the data center 165) can migrate the computations 169a associated with the mapping function to the API end point 173 at the edge of the cloud service 163 domain as computations 169b using the approach of the various embodiments described herein. The computations 169b can then be used to process the data set in places 171 to respond to the request or query from the partner services 161a-161b. In this way, the system 100 improves latency and availability of the mapping function. In one embodiment, the API 173 may return only the results of the computations 169b without exposing the entire data set in places 171, thereby avoiding exposure of the entirety of places 171 to the partners.

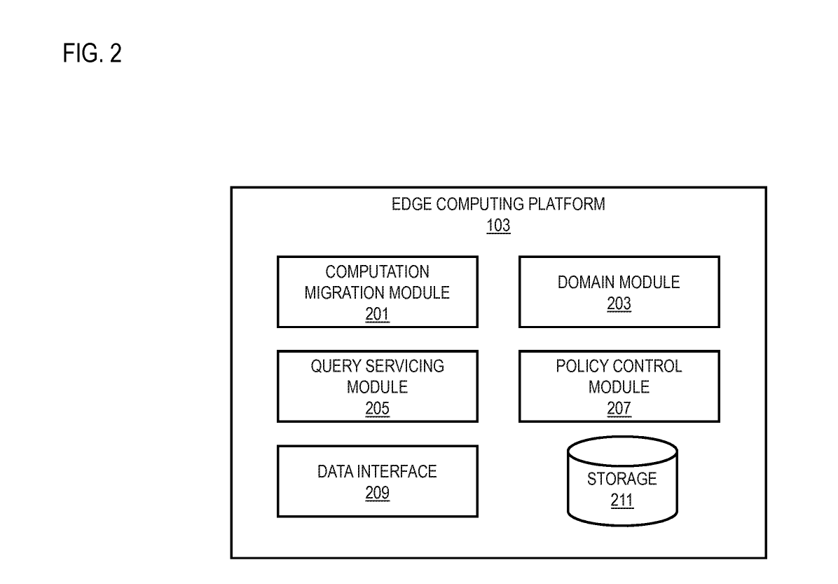

FIG. 2 is a diagram of the components of an edge computing platform, according to one embodiment. By way of example, the edge computing platform 111 includes one or more components for providing edge-based interoperability of data and functions. It is contemplated that the functions of these components may be combined in one or more components or performed by other components of equivalent functionality. Moreover, although the edge computing platform 111 is depicted as a single component, it is contemplated that one or more components of the edge computing platform 111 can be distributed to other components or nodes of the cloud computing architecture. In this embodiment, the edge computing platform 111 includes a computation migration module 201, a domain module 203, a query servicing module 205, a policy control module 207, a data interface 209, and a storage 211.

In one embodiment, the computation migration module 201 executes one or more algorithms for providing edge-based interoperability of data and computations. More specifically, the computation migration module 201 colocates or otherwise associates data and computations (e.g., as computation closures) so that the data and/or computations can be stored and/or migrated among different nodes 123-127 of a cloud computing architecture.

In one embodiment, the computation migration module 201 interacts with the domain module 203 to determine whether specific data, computations, or a computation closures may cross different domains (e.g., different services 103, different data centers 135, different nodes 123-127, different functions of the services 103, etc.). The domain module 203 may then map or store the topology of a cloud computing architecture associated with the services 103 to identify different layers (e.g., core layer 141, regional layer 143, and edge layer 145) to facilitate migration of the data, computations, and/or computation closures among nodes 123-127 of the cloud computing layers 141-145. In other words, the computation migration module 201 can use the network topology information to make decisions on where, when, how, etc. to migrate data, computations, and/or computations closures within the cloud computing architecture.

In one embodiment, the computation migration module 201 migrates the data, computations, and/or computation closures in serialized form. In one embodiment, the serialization may be generated and stored using Resource Description Framework (RDF) format. RDF is a family of World Wide Web Consortium (W3C) specifications originally designed as a metadata data model. It has come to be used as a general method for conceptual description or modeling of information that is implemented in web resources; using a variety of syntax formats. The underlying structure of any expression in RDF is a collection of triples, each consisting of three disjoint sets of nodes including a subject, a predicate and an object. A subject is an RDF URI reference (U) or a Blank Node (B), a predicate is an RDF URI reference (U), and an object is an RDF URI reference (U), a literal (L) or a Blank Node (B). A set of such triples is called an RDF graph. Table 1 shows an example RDF graph structure.

TABLE 1

| Subject | Predicate | Object |
|---|---|---|
| uri://....../rule#CD- | rdf:type, | uri://............/Rule |
| introduction, | | |
| uri://....../rule#CD- | uri://....../rule#assumption, | “c” |
| introduction, | | |

By way of example, serialization enables both granularity and reflectivity of the data, computation, and/or computation closures. In one embodiment, the granularity may be achieved by the basic format of operation (e.g. RDF) within the specific computation environment. Furthermore, the reflectivity of processes (e.g., the capability of processes to provide a representation of their own behavior to be used for inspection and/or adaptation) may be achieved by encoding the behavior of the computation in RDF format. Additionally, the context may be assumed to be partly predetermined and stored as RDF in the information space and partly be extracted from the execution environment. It is noted that the RDF structures can be seen as subgraphs, RDF molecules (e.g., the building blocks of RDF graphs) or named graphs in the semantic information brokers (SIBs) of information spaces.

In certain embodiments serializing the data, computation, and/or computation closures associated with a certain execution context enables the closures to be freely distributed among the different nodes of a cloud computing architecture, as well as among multiple UEs 101 and/or devices, including remote processors associated with the UEs 101. In one embodiment, the processes of closure assigning and migration to run-time environments may be performed based on a cost function, which accepts as input variables for a cost determination algorithm those environmental or procedural factors that impact optimal processing capability from the perspective of the multiple nodes 123-127 of the cloud computing architecture. Such factors may include, but are not limited to, the required processing power for each process, system resource load, resource availability, capabilities of the available run-time environments, processing required to be performed, load balancing considerations, security considerations, privacy considerations, etc. As such, the cost function is, at least in part, an algorithmic or procedural execution for evaluating, weighing or determining the requisite operational gains achieved and/or cost expended as a result of the differing closure assignment and migration possibilities. In embodiment, the assignment and migration process is to be performed in light of that which presents the least cost relative to present environmental or functional conditions.

It is noted that the computation migration module 201 may perform the serialization based on the one or more object models, context models, or the like. In generating the serialization, the serialized data, computations, and/or computation closures may reference or integrate specific structured data items, one or more pointers to one or more of the binary or unstructured data items, or a combination thereof. By way of example, a serialization may include a pointer for referencing the location of a specific binary image given its large size, while a serialization of structured data may be more readily integrated for direct replication across nodes 123-127. In one embodiment, binding of the serialization enables the related computation to be presented as a part of the structured data object. Thus it can be presented along with the data object for granular and reflective run-time processing.

In one embodiment, the computation migration module 201 can interact with the query servicing module 205 to respond to requests and/or queries for data, computations, and/or computation closures. By way of example, these requests may be generated by the cloud services 103 and or partner services associated with cloud service 130. In another embodiment, the query servicing module 205 receives a request or query from one or more of the nodes 123-127 or another component of the cloud computing architecture have connectivity to the edge computing platform 111 over the communication network 105. In one embodiment, the query processing module 205 determines the data, computations, and/or computation closures that are needed for processing the request or query to generate results for return to the requestor.

In one embodiment, the query servicing module 205 can interact with the policy control module 207 to determine what results and/or data, computations, and computation closures that the policy control module 207 can expose to the requestor. For example, the policy control module 207 can determine whether there are any policies (e.g., privacy policies, security policies, network policies, etc.) that restrict or otherwise limit results, data, computations, and/or computation closures can be exposed. For example, policies may specify that the query servicing module 205 may return only results and not any underlying data, computations, or closures used to generate the results. In another example, policies may specify obscuring or increasing the granularity of the results (e.g., increase the granularity of location data associated with a user).

In one embodiment, data requests or queries and/or their results are transmitted or received via the data interface 209. In one embodiment, the data interface 209 is comprised of one or more API end points 151. As previously discussed, the API end points 151 can be based on a standard data and computation sharing protocol such as the Open Data Protocol (OData). It is contemplated that any protocol, including standardized and proprietary protocols, may be used in the various embodiments described herein.

In one embodiment, the computation migration module 201 can store data, computations, and/or computation closures in the storage 211 for migration or use by the query servicing module 205. In one embodiment, the storage 211 may include one or more of the information spaces 107 and/or computation stores 109 of the cloud services 103.

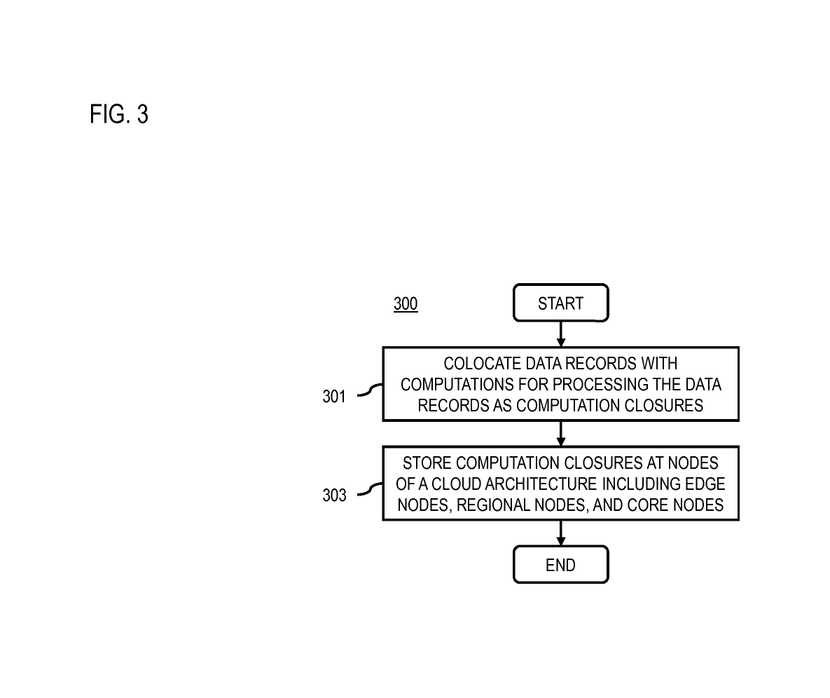

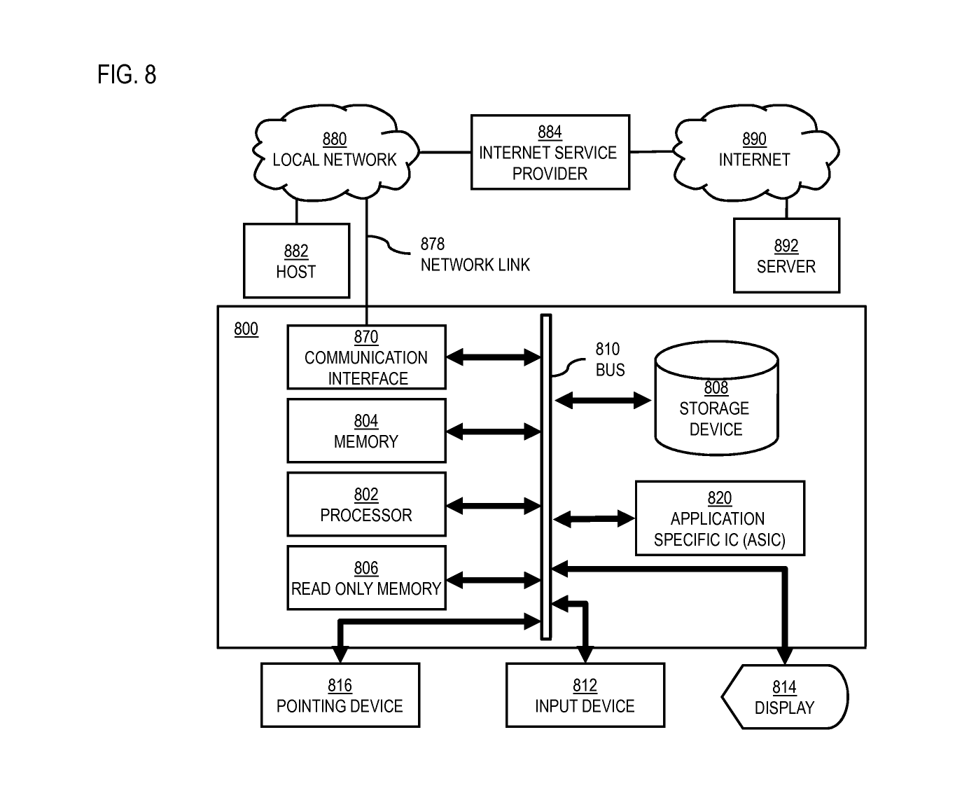

FIG. 3 is a flowchart of a process for providing computation closures to enable edge-based interoperability of data and computations, according to one embodiment. In one embodiment, the edge computing platform 111 performs the process 300 and is implemented in, for instance, a chip set including a processor and a memory as shown in FIG. 8.

In step 301, the edge computing platform 111 causes, at least in part, a colocation one or more data records with one or more computations as one or more computation closures. In one embodiment, the one or more computations are for processing the one the one or more data records. In one embodiment, colocation refers to storing the data records in at least a proximate location with the computations that operate on the data. In the case of a computation closure, the data and the computations are serialized into a common data or digital object to cause the colocation.

The edge computing platform 111 then causes, at least in part, a storage of the one or more computation closures at one or more nodes of at least one cloud computing architecture for servicing one or more queries. In one embodiment, the one or more nodes include, at least in part, one or more edge nodes 127, one or more regional nodes 125, one or more core nodes 123, or a combination thereof. By way of example, the one or more edge nodes 127 represent one or more boundaries between one or more domains of the at least one cloud computing architecture. As previously, discussed the edge computing platform 111 can determine which of the nodes 123-127 based on resource load information, resource availability information, and/or other cost parameters.

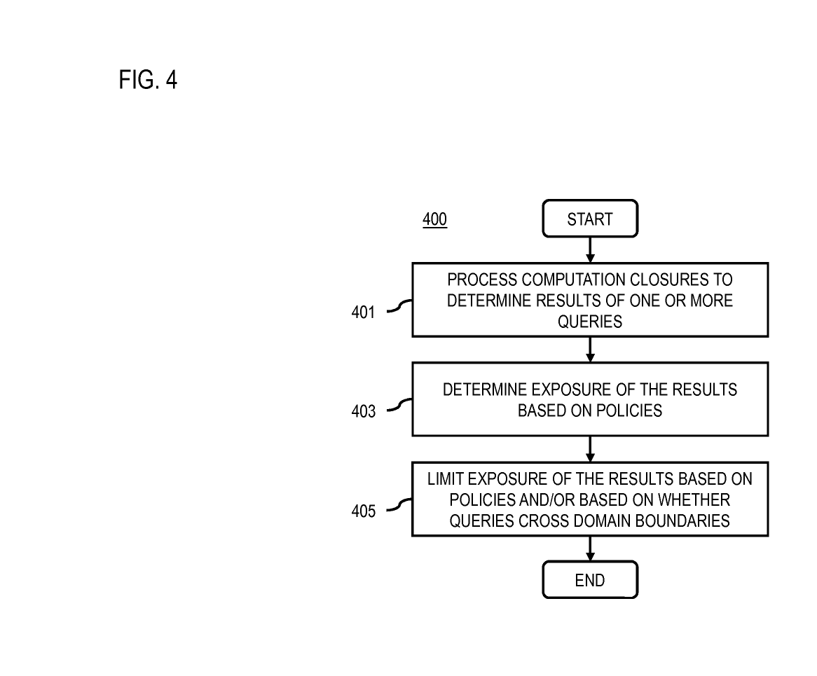

FIG. 4 is a flowchart of a process for determining the exposure query results generated using edge-based interoperability for data and computations, according to one embodiment. In one embodiment, the edge computing platform 111 performs the process 400 and is implemented in, for instance, a chip set including a processor and a memory as shown in FIG. 8.

In step 401, the edge computing platform 111 processes and/or facilitates a processing of one or more computations or computation closures to determine one or more results of one or more queries and/or data requests. In one embodiment, the queries and/or requests are received from services with edge-based interoperability of data and computations.

In step 403, the edge computing platform 111 determines an exposure of the one or more results of the one or more computation closures, the one or more data records, the one or more computations, or a combination in response to the one or more queries based, at least in part, on one or more privacy policies. In one embodiment, exposure refers to whether the edge computing platform 111 will display, present, or otherwise provide access to the results, data, computations, and/or computation platforms to other services, nodes 123-127, or other components of the system 100. In some embodiment, the edge computing platform 111 may determine the exposure based on other policies (e.g., security policies) or preferences from the user, service provider, data owner, etc.

In one embodiment, the edge computing platform 111 causes, at least in part, a limitation of the exposure to the one or more results of the one or more computation closures (step 405). In one embodiment, the limitation is based, at least in part, on (a) the one or more privacy policies, (b) whether the one or more queries cross the one or more boundaries between the one or more domains, or (c) a combination thereof. For example, the limitation may include identifying which nodes 123-127, services 103, entities, etc. should have access to the results, data, computations, and/or computation closures. In one embodiment, the limitation may include obscuring or altering the results, data, computations, and/or computation closures so that a limited version can be provided in placed of the actual results, data, computations, and/or computation closures. Such a limited version may be generated by obscuring or altering the granularity of the results, data, computations, and/or computation closures (e.g., changing the granularity of a location from a street address to a city).

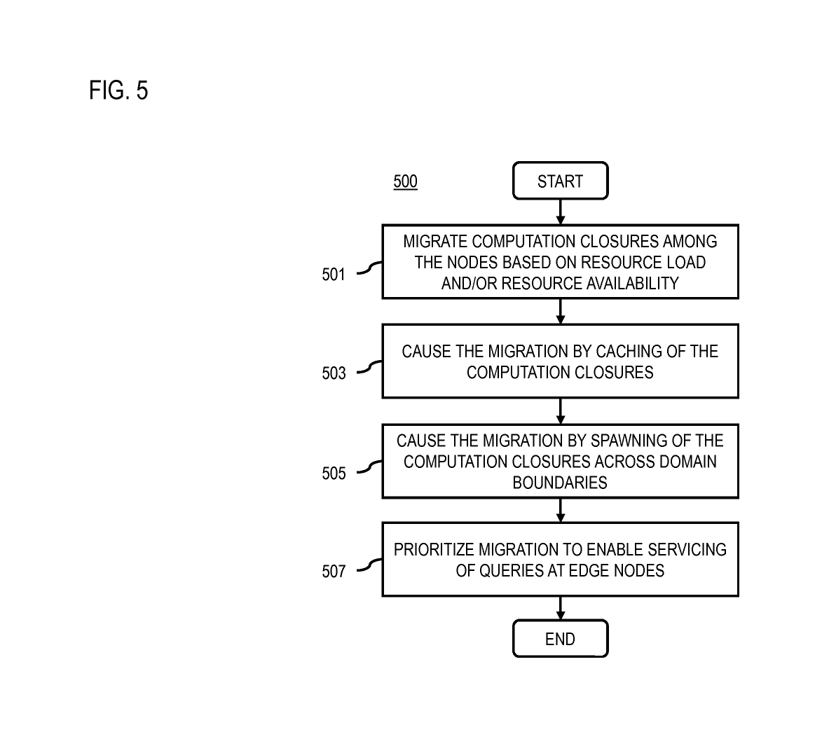

FIG. 5 is a flowchart of a process for migrating computation closures within a cloud computing architecture to facilitate edge-based interoperability of data and computations, according to one embodiment. In one embodiment, the edge computing platform 111 performs the process 500 and is implemented in, for instance, a chip set including a processor and a memory as shown in FIG. 8.

In step 501, the edge computing platform 111 causes, at least in part, a migration of the one or more computation closures, the one or more data records, the one or more computations, or a combination thereof among the one or more nodes based, at least in part, on resource load information, resource availability information, or a combination thereof associated with the at least one cloud computing architecture.

In step 503, the edge computing platform 111 causes, at least in part, a caching of the one or more computation closures, the one or more data records, the one or more computations, or a combination thereof at the one or more edge nodes, the one or more regional nodes, the one or more core nodes, or a combination thereof. The edge computing platform 111 then causes, at least in part, a determination of one or more results of the one or more queries based, at least in part, on the caching. In one embodiment, the caching enables the edge computing platform 111 to determine whether to dynamically generate or pre-generate results of popular requests, functions, queries, etc.

For example, in the case of location based services, the edge computing platform 111 can determine whether to dynamically generate or pre-generate map tiles in response to service requests. In one embodiment, the edge computing platform 111 may determine whether to dynamically generate or pre-generate map tiles or other results based on factors such as the speed of generating the tile or result, the frequency of updates to the map tile data or other underlying date, and the like. For example, if tiles or results can be generated quickly, then pre-generating and caching the pre-generated results may be less preferred. Similarly, if map data or other data updates are frequent, then pre-generation may be less preferred.

In some embodiments, the edge computing platform 111 can take a hybrid approach between dynamically generating or pre-generating map tiles or other results. For example, the edge computing platform 111 can maintain dynamic aspects and at the same time optimize pre-generation or response times based on set criteria. For example, for location-based services, the criteria may be set based on available analytics and may include any combination of: (1) request frequency—a criteria that can specify that a top x millions of tiles sorted by number of requests should be pre-generated; (2) zoom level—one or more zoom levels could be used as the criteria for pre-generation of a subset of tiles with more frequently requested zoom levels being pre-generated; (3) geo regions—map tiles from the most frequently requested regions can be pre-generated; (4) time of day—map tiles most frequently requested at a particular time of day can be pre-generated during that time of day.

In other embodiments, other functions for location-based services may be cached. These functions or services include (1) routing and related information (e.g., historic road conditions, traffic conditions, time of trip, and other trip preferences such as scenic routes, etc.); (2) caching of routes and/or route identifiers for retrieval of previously computed routes; (3) pre-computing routes based on availability of platform resources where each data center 135 or node 123-127 can pre-compute frequent or popular routes when computing resources are available and would otherwise be idle.

In step 505, the edge computing platform 111 causes, at least in part, a spawning of the one or more computation closures, the one or more data records, the one or more computations, or a combination thereof across the one or more boundaries of the one or more domains. In one embodiment, the spawning is facilitated via one or more application interfaces at the one or more boundaries. For example, spawning computation closures across boundaries enables the edge computing platform 111 to decompose computation tasks (e.g., queries) into smaller building blocks that can be serviced by nodes in different domains. The results from the building block tasks can then be aggregated at, for instance, edge nodes 127 between the domains for delivery to the end user.

In step 507, the edge computing platform 111 causes, at least in part, a prioritization of the migration of the one or more data records and the one or more computations to the one or more edges. In one embodiment, the prioritization facilitates, at least in part, the servicing of the one or more queries at the one or more edge nodes. For example, core nodes 123 and/or regional nodes 125 typically are responsible for servicing a greater number or users or larger geographical regions. Accordingly, the work load on the regional nodes 125 and/or core nodes 123 can often be greater than the load on any individual edge node 127. Moreover, the regional nodes 125 and/or core nodes can be located farther away than edge nodes 127 from end users which can affect response times and latency.

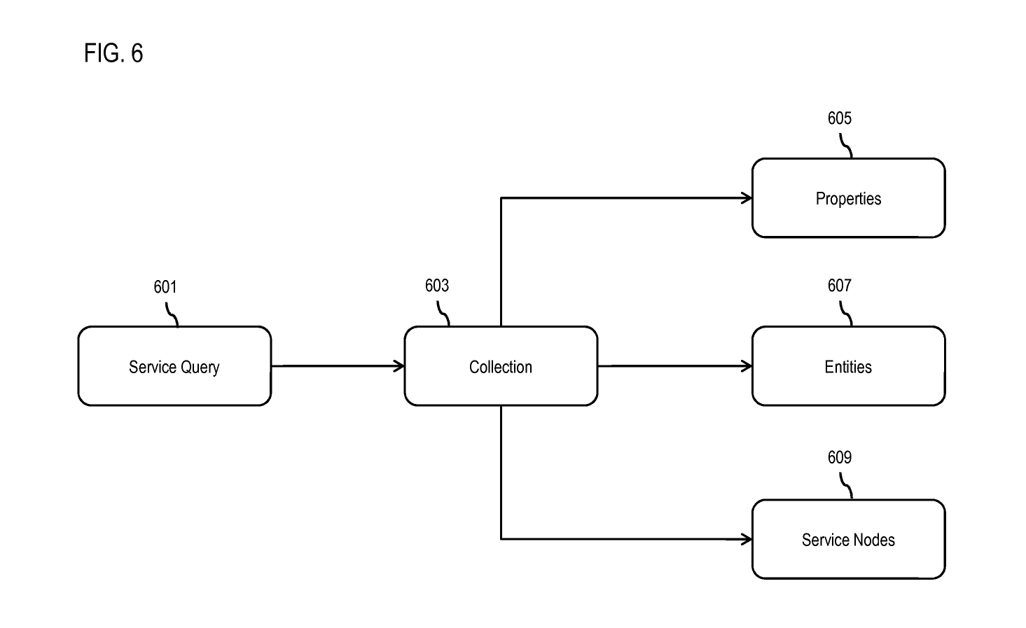

FIG. 6 is a diagram of a decomposition of service queries for edge-based interoperability of data and computations, according to one embodiment. In the example of FIG. 6, a service query 601 is received and decomposed to determine a collection 603 of data, computations, and/or computation closures might be responsive to the service query 601. For example, in a cloud computing environment, the data, computations, and/or computation closures that can provided results to the service query 601 can be associated with a sources distributed over any number of nodes 123-127, domains, data centers 135, etc. In one embodiment, the sources may be owned or otherwise associated with the service 103 initiating the query or may be owned or otherwise associated with other services 103 or components.

In this case, the system 100 (e.g., via the edge computing platform 111) processes the service query 601 to determine which properties 605, entities 607, and/or service nodes 609 may have responsive data. For example, properties 605 may include physical data centers 135, appliances, and/or other infrastructure components. Entities 607, for instance, may include other information source both virtual and/or physical (e.g., public databases), and service nodes 609 may include any nodes 123-127 of one or more cloud services 103.

In one embodiment, the system 100 operates on the service query 601 as a computation task. In this case, the decomposition of the computation task or query 601 includes decomposing the task into smaller units of work or building blocks. Once decomposed, the query can be serialized and migrated from the originating service 103 to each of the identified sources in the collection 603. In some cases, the decomposition processes include adapting the query specifically to the intended source. For example, a source specific query may be modified based on various parameters (e.g., resource availability, resource load, available data types, scope of data, etc.) to ensure efficient processing at the sources. The results of each of the smaller work units or building blocks can then be aggregated to provide the results of the service query 601.

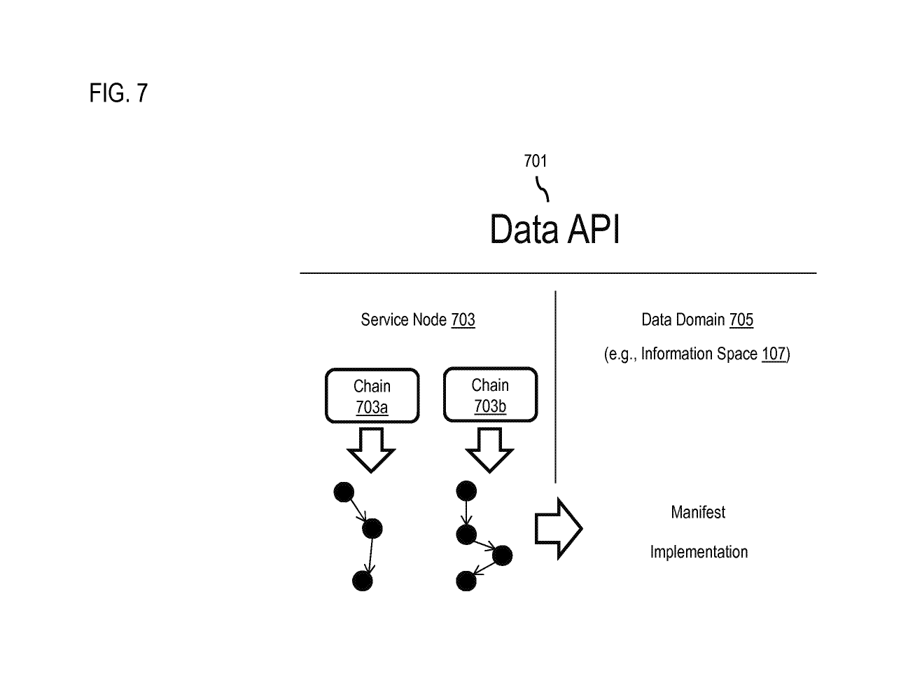

FIG. 7 is a diagram of a data application programming interface for providing edge-based interoperability of data and computations, according to one embodiment. The example of FIG. 7 illustrates a Data API end point 701 (e.g., API end point 151) that facilitates migration of queries, data, computations, and/or computation closures across domain boundaries or edges. For example, depending on the functions called by a requesting node, the Data API 701 can dynamically allocation computations (e.g., computation chains 703a-703b) of, for instance, service node 703 based on which computations, data, and/or computation closures are needed to responds to the query.

The Data API end point 701 then enables the outsourcing to the edges of the data domain 705 (e.g., an information space 107) that has the data, computations, and/or computation closures that are potentially responsive to a given API call. In one embodiment, as described above, the outsourcing can include decomposing the chains 703a-703b into smaller units of work or building blocks. When such a decomposition occurs, the Data API end point 701 can provide a manifest of the building blocks. This manifest can then be migrated to the edge nodes 127 where results can be returned and aggregated according to the manifest. In one embodiment, the execution of the building blocks to generate the results can be migrated to other nodes (e.g., regional nodes 125 or core nodes 123) for processing with results of the processing returned to the edge nodes 127.

In one embodiment, the outsourcing process, as facilitated by the Data API end point 701, may also including implementing the chains 703a-703b in the data domain 705 in a key-value manner. In other words, the results are provided as key-value pairs. In this way, key-value pairs for individual building blocks can be migrated to the edge nodes 127 along with the manifest to construct the final results of an API call.

The processes described herein for providing edge-based interoperability of data and computations may be advantageously implemented via software, hardware, firmware or a combination of software and/or firmware and/or hardware. For example, the processes described herein, may be advantageously implemented via processor(s), Digital Signal Processing (DSP) chip, an Application Specific Integrated Circuit (ASIC), Field Programmable Gate Arrays (FPGAs), etc. Such exemplary hardware for performing the described functions is detailed below.

FIG. 8 illustrates a computer system 800 upon which an embodiment of the invention may be implemented. Although computer system 800 is depicted with respect to a particular device or equipment, it is contemplated that other devices or equipment (e.g., network elements, servers, etc.) within FIG. 8 can deploy the illustrated hardware and components of system 800. Computer system 800 is programmed (e.g., via computer program code or instructions) to provide edge-based interoperability of data and computations as described herein and includes a communication mechanism such as a bus 810 for passing information between other internal and external components of the computer system 800. Information (also called data) is represented as a physical expression of a measurable phenomenon, typically electric voltages, but including, in other embodiments, such phenomena as magnetic, electromagnetic, pressure, chemical, biological, molecular, atomic, sub-atomic and quantum interactions. For example, north and south magnetic fields, or a zero and non-zero electric voltage, represent two states (0, 1) of a binary digit (bit). Other phenomena can represent digits of a higher base. A superposition of multiple simultaneous quantum states before measurement represents a quantum bit (qubit). A sequence of one or more digits constitutes digital data that is used to represent a number or code for a character. In some embodiments, information called analog data is represented by a near continuum of measurable values within a particular range. Computer system 800, or a portion thereof, constitutes a means for performing one or more steps of providing edge-based interoperability of data and computations.

A bus 810 includes one or more parallel conductors of information so that information is transferred quickly among devices coupled to the bus 810. One or more processors 802 for processing information are coupled with the bus 810.

A processor (or multiple processors) 802 performs a set of operations on information as specified by computer program code related to providing edge-based interoperability of data and computations. The computer program code is a set of instructions or statements providing instructions for the operation of the processor and/or the computer system to perform specified functions. The code, for example, may be written in a computer programming language that is compiled into a native instruction set of the processor. The code may also be written directly using the native instruction set (e.g., machine language). The set of operations include bringing information in from the bus 810 and placing information on the bus 810. The set of operations also typically include comparing two or more units of information, shifting positions of units of information, and combining two or more units of information, such as by addition or multiplication or logical operations like OR, exclusive OR (XOR), and AND. Each operation of the set of operations that can be performed by the processor is represented to the processor by information called instructions, such as an operation code of one or more digits. A sequence of operations to be executed by the processor 802, such as a sequence of operation codes, constitute processor instructions, also called computer system instructions or, simply, computer instructions. Processors may be implemented as mechanical, electrical, magnetic, optical, chemical or quantum components, among others, alone or in combination.

Computer system 800 also includes a memory 804 coupled to bus 810. The memory 804, such as a random access memory (RAM) or any other dynamic storage device, stores information including processor instructions for providing edge-based interoperability of data and computations. Dynamic memory allows information stored therein to be changed by the computer system 800. RAM allows a unit of information stored at a location called a memory address to be stored and retrieved independently of information at neighboring addresses. The memory 804 is also used by the processor 802 to store temporary values during execution of processor instructions. The computer system 800 also includes a read only memory (ROM) 806 or any other static storage device coupled to the bus 810 for storing static information, including instructions, that is not changed by the computer system 800. Some memory is composed of volatile storage that loses the information stored thereon when power is lost. Also coupled to bus 810 is a non-volatile (persistent) storage device 808, such as a magnetic disk, optical disk or flash card, for storing information, including instructions, that persists even when the computer system 800 is turned off or otherwise loses power.

Information, including instructions for providing edge-based interoperability of data and computations, is provided to the bus 810 for use by the processor from an external input device 812, such as a keyboard containing alphanumeric keys operated by a human user, a microphone, an Infrared (IR) remote control, a joystick, a game pad, a stylus pen, a touch screen, or a sensor. A sensor detects conditions in its vicinity and transforms those detections into physical expression compatible with the measurable phenomenon used to represent information in computer system 800. Other external devices coupled to bus 810, used primarily for interacting with humans, include a display device 814, such as a cathode ray tube (CRT), a liquid crystal display (LCD), a light emitting diode (LED) display, an organic LED (OLED) display, a plasma screen, or a printer for presenting text or images, and a pointing device 816, such as a mouse, a trackball, cursor direction keys, or a motion sensor, for controlling a position of a small cursor image presented on the display 814 and issuing commands associated with graphical elements presented on the display 814. In some embodiments, for example, in embodiments in which the computer system 800 performs all functions automatically without human input, one or more of external input device 812, display device 814 and pointing device 816 is omitted.

In the illustrated embodiment, special purpose hardware, such as an application specific integrated circuit (ASIC) 820, is coupled to bus 810. The special purpose hardware is configured to perform operations not performed by processor 802 quickly enough for special purposes. Examples of ASICs include graphics accelerator cards for generating images for display 814, cryptographic boards for encrypting and decrypting messages sent over a network, speech recognition, and interfaces to special external devices, such as robotic arms and medical scanning equipment that repeatedly perform some complex sequence of operations that are more efficiently implemented in hardware.

Computer system 800 also includes one or more instances of a communications interface 870 coupled to bus 810. Communication interface 870 provides a one-way or two-way communication coupling to a variety of external devices that operate with their own processors, such as printers, scanners and external disks. In general the coupling is with a network link 878 that is connected to a local network 880 to which a variety of external devices with their own processors are connected. For example, communication interface 870 may be a parallel port or a serial port or a universal serial bus (USB) port on a personal computer. In some embodiments, communications interface 870 is an integrated services digital network (ISDN) card or a digital subscriber line (DSL) card or a telephone modem that provides an information communication connection to a corresponding type of telephone line. In some embodiments, a communication interface 870 is a cable modem that converts signals on bus 810 into signals for a communication connection over a coaxial cable or into optical signals for a communication connection over a fiber optic cable. As another example, communications interface 870 may be a local area network (LAN) card to provide a data communication connection to a compatible LAN, such as Ethernet. Wireless links may also be implemented. For wireless links, the communications interface 870 sends or receives or both sends and receives electrical, acoustic or electromagnetic signals, including infrared and optical signals, that carry information streams, such as digital data. For example, in wireless handheld devices, such as mobile telephones like cell phones, the communications interface 870 includes a radio band electromagnetic transmitter and receiver called a radio transceiver. In certain embodiments, the communications interface 870 enables connection to the communication network 105 for providing edge-based interoperability of data and computations.

The term “computer-readable medium” as used herein refers to any medium that participates in providing information to processor 802, including instructions for execution. Such a medium may take many forms, including, but not limited to computer-readable storage medium (e.g., non-volatile media, volatile media), and transmission media. Non-transitory media, such as non-volatile media, include, for example, optical or magnetic disks, such as storage device 808. Volatile media include, for example, dynamic memory 804. Transmission media include, for example, twisted pair cables, coaxial cables, copper wire, fiber optic cables, and carrier waves that travel through space without wires or cables, such as acoustic waves and electromagnetic waves, including radio, optical and infrared waves. Signals include man-made transient variations in amplitude, frequency, phase, polarization or other physical properties transmitted through the transmission media. Common forms of computer-readable media include, for example, a floppy disk, a flexible disk, hard disk, magnetic tape, any other magnetic medium, a CD-ROM, CDRW, DVD, any other optical medium, punch cards, paper tape, optical mark sheets, any other physical medium with patterns of holes or other optically recognizable indicia, a RAM, a PROM, an EPROM, a FLASH-EPROM, an EEPROM, a flash memory, any other memory chip or cartridge, a carrier wave, or any other medium from which a computer can read. The term computer-readable storage medium is used herein to refer to any computer-readable medium except transmission media.

Logic encoded in one or more tangible media includes one or both of processor instructions on a computer-readable storage media and special purpose hardware, such as ASIC 820.

Network link 878 typically provides information communication using transmission media through one or more networks to other devices that use or process the information. For example, network link 878 may provide a connection through local network 880 to a host computer 882 or to equipment 884 operated by an Internet Service Provider (ISP). ISP equipment 884 in turn provides data communication services through the public, world-wide packet-switching communication network of networks now commonly referred to as the Internet 890.

A computer called a server host 892 connected to the Internet hosts a process that provides a service in response to information received over the Internet. For example, server host 892 hosts a process that provides information representing video data for presentation at display 814. It is contemplated that the components of system 800 can be deployed in various configurations within other computer systems, e.g., host 882 and server 892.

At least some embodiments of the invention are related to the use of computer system 800 for implementing some or all of the techniques described herein. According to one embodiment of the invention, those techniques are performed by computer system 800 in response to processor 802 executing one or more sequences of one or more processor instructions contained in memory 804. Such instructions, also called computer instructions, software and program code, may be read into memory 804 from another computer-readable medium such as storage device 808 or network link 878. Execution of the sequences of instructions contained in memory 804 causes processor 802 to perform one or more of the method steps described herein. In alternative embodiments, hardware, such as ASIC 820, may be used in place of or in combination with software to implement the invention. Thus, embodiments of the invention are not limited to any specific combination of hardware and software, unless otherwise explicitly stated herein.

The signals transmitted over network link 878 and other networks through communications interface 870, carry information to and from computer system 800. Computer system 800 can send and receive information, including program code, through the networks 880, 890 among others, through network link 878 and communications interface 870. In an example using the Internet 890, a server host 892 transmits program code for a particular application, requested by a message sent from computer 800, through Internet 890, ISP equipment 884, local network 880 and communications interface 870. The received code may be executed by processor 802 as it is received, or may be stored in memory 804 or in storage device 808 or any other non-volatile storage for later execution, or both. In this manner, computer system 800 may obtain application program code in the form of signals on a carrier wave.

Various forms of computer readable media may be involved in carrying one or more sequence of instructions or data or both to processor 802 for execution. For example, instructions and data may initially be carried on a magnetic disk of a remote computer such as host 882. The remote computer loads the instructions and data into its dynamic memory and sends the instructions and data over a telephone line using a modem. A modem local to the computer system 800 receives the instructions and data on a telephone line and uses an infra-red transmitter to convert the instructions and data to a signal on an infra-red carrier wave serving as the network link 878. An infrared detector serving as communications interface 870 receives the instructions and data carried in the infrared signal and places information representing the instructions and data onto bus 810. Bus 810 carries the information to memory 804 from which processor 802 retrieves and executes the instructions using some of the data sent with the instructions. The instructions and data received in memory 804 may optionally be stored on storage device 808, either before or after execution by the processor 802.

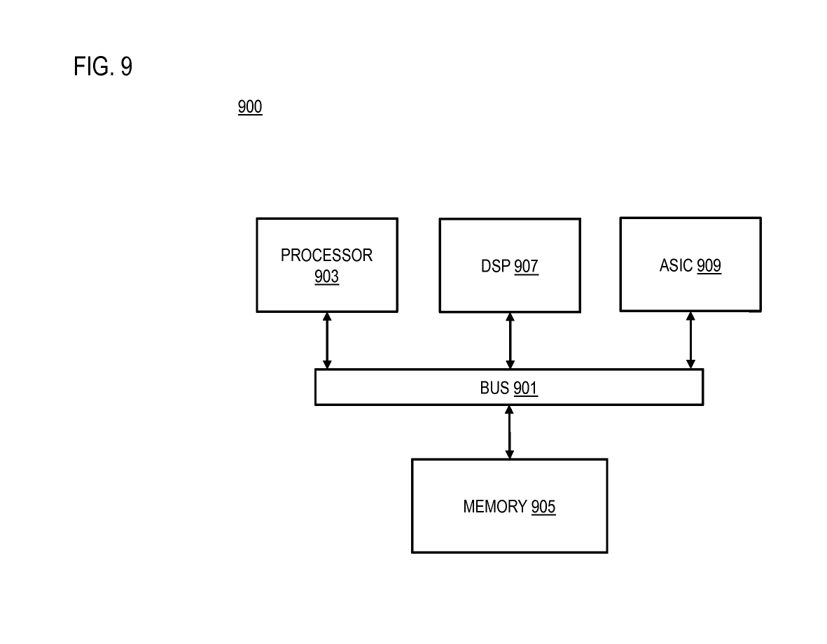

FIG. 9 illustrates a chip set or chip 900 upon which an embodiment of the invention may be implemented. Chip set 900 is programmed to provide edge-based interoperability of data and computations as described herein and includes, for instance, the processor and memory components described with respect to FIG. 8 incorporated in one or more physical packages (e.g., chips). By way of example, a physical package includes an arrangement of one or more materials, components, and/or wires on a structural assembly (e.g., a baseboard) to provide one or more characteristics such as physical strength, conservation of size, and/or limitation of electrical interaction. It is contemplated that in certain embodiments the chip set 900 can be implemented in a single chip. It is further contemplated that in certain embodiments the chip set or chip 900 can be implemented as a single “system on a chip.” It is further contemplated that in certain embodiments a separate ASIC would not be used, for example, and that all relevant functions as disclosed herein would be performed by a processor or processors. Chip set or chip 900, or a portion thereof, constitutes a means for performing one or more steps of providing user interface navigation information associated with the availability of functions. Chip set or chip 900, or a portion thereof, constitutes a means for performing one or more steps of providing edge-based interoperability of data and computations.

In one embodiment, the chip set or chip 900 includes a communication mechanism such as a bus 901 for passing information among the components of the chip set 900. A processor 903 has connectivity to the bus 901 to execute instructions and process information stored in, for example, a memory 905. The processor 903 may include one or more processing cores with each core configured to perform independently. A multi-core processor enables multiprocessing within a single physical package. Examples of a multi-core processor include two, four, eight, or greater numbers of processing cores. Alternatively or in addition, the processor 903 may include one or more microprocessors configured in tandem via the bus 901 to enable independent execution of instructions, pipelining, and multithreading. The processor 903 may also be accompanied with one or more specialized components to perform certain processing functions and tasks such as one or more digital signal processors (DSP) 907, or one or more application-specific integrated circuits (ASIC) 909. A DSP 907 typically is configured to process real-world signals (e.g., sound) in real time independently of the processor 903. Similarly, an ASIC 909 can be configured to performed specialized functions not easily performed by a more general purpose processor. Other specialized components to aid in performing the inventive functions described herein may include one or more field programmable gate arrays (FPGA), one or more controllers, or one or more other special-purpose computer chips.

In one embodiment, the chip set or chip 900 includes merely one or more processors and some software and/or firmware supporting and/or relating to and/or for the one or more processors.

The processor 903 and accompanying components have connectivity to the memory 905 via the bus 901. The memory 905 includes both dynamic memory (e.g., RAM, magnetic disk, writable optical disk, etc.) and static memory (e.g., ROM, CD-ROM, etc.) for storing executable instructions that when executed perform the inventive steps described herein to provide edge-based interoperability of data and computations. The memory 905 also stores the data associated with or generated by the execution of the inventive steps.

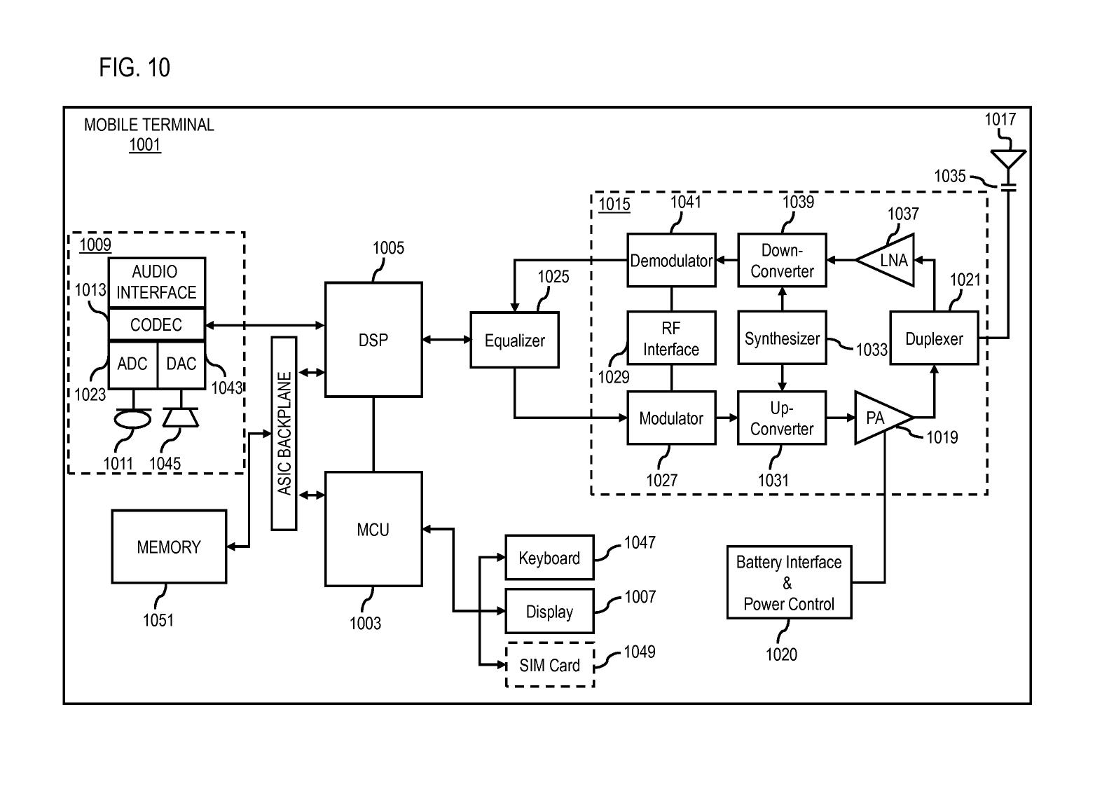

FIG. 10 is a diagram of exemplary components of a mobile terminal (e.g., handset) for communications, which is capable of operating in the system of FIG. 1, according to one embodiment. In some embodiments, mobile terminal 1001, or a portion thereof, constitutes a means for performing one or more steps of providing edge-based interoperability of data and computations. Generally, a radio receiver is often defined in terms of front-end and back-end characteristics. The front-end of the receiver encompasses all of the Radio Frequency (RF) circuitry whereas the back-end encompasses all of the base-band processing circuitry. As used in this application, the term “circuitry” refers to both: (1) hardware-only implementations (such as implementations in only analog and/or digital circuitry), and (2) to combinations of circuitry and software (and/or firmware) (such as, if applicable to the particular context, to a combination of processor(s), including digital signal processor(s), software, and memory(ies) that work together to cause an apparatus, such as a mobile phone or server, to perform various functions). This definition of “circuitry” applies to all uses of this term in this application, including in any claims. As a further example, as used in this application and if applicable to the particular context, the term “circuitry” would also cover an implementation of merely a processor (or multiple processors) and its (or their) accompanying software/or firmware. The term “circuitry” would also cover if applicable to the particular context, for example, a baseband integrated circuit or applications processor integrated circuit in a mobile phone or a similar integrated circuit in a cellular network device or other network devices.

Pertinent internal components of the telephone include a Main Control Unit (MCU) 1003, a Digital Signal Processor (DSP) 1005, and a receiver/transmitter unit including a microphone gain control unit and a speaker gain control unit. A main display unit 1007 provides a display to the user in support of various applications and mobile terminal functions that perform or support the steps of providing edge-based interoperability of data and computations. The display 1007 includes display circuitry configured to display at least a portion of a user interface of the mobile terminal (e.g., mobile telephone). Additionally, the display 1007 and display circuitry are configured to facilitate user control of at least some functions of the mobile terminal. An audio function circuitry 1009 includes a microphone 1011 and microphone amplifier that amplifies the speech signal output from the microphone 1011. The amplified speech signal output from the microphone 1011 is fed to a coder/decoder (CODEC) 1013.

A radio section 1015 amplifies power and converts frequency in order to communicate with a base station, which is included in a mobile communication system, via antenna 1017. The power amplifier (PA) 1019 and the transmitter/modulation circuitry are operationally responsive to the MCU 1003, with an output from the PA 1019 coupled to the duplexer 1021 or circulator or antenna switch, as known in the art. The PA 1019 also couples to a battery interface and power control unit 1020.

In use, a user of mobile terminal 1001 speaks into the microphone 1011 and his or her voice along with any detected background noise is converted into an analog voltage. The analog voltage is then converted into a digital signal through the Analog to Digital Converter (ADC) 1023. The control unit 1003 routes the digital signal into the DSP 1005 for processing therein, such as speech encoding, channel encoding, encrypting, and interleaving. In one embodiment, the processed voice signals are encoded, by units not separately shown, using a cellular transmission protocol such as enhanced data rates for global evolution (EDGE), general packet radio service (GPRS), global system for mobile communications (GSM), Internet protocol multimedia subsystem (IMS), universal mobile telecommunications system (UMTS), etc., as well as any other suitable wireless medium, e.g., microwave access (WiMAX), Long Term Evolution (LTE) networks, code division multiple access (CDMA), wideband code division multiple access (WCDMA), wireless fidelity (WiFi), satellite, and the like, or any combination thereof.

The encoded signals are then routed to an equalizer 1025 for compensation of any frequency-dependent impairments that occur during transmission though the air such as phase and amplitude distortion. After equalizing the bit stream, the modulator 1027 combines the signal with a RF signal generated in the RF interface 1029. The modulator 1027 generates a sine wave by way of frequency or phase modulation. In order to prepare the signal for transmission, an up-converter 1031 combines the sine wave output from the modulator 1027 with another sine wave generated by a synthesizer 1033 to achieve the desired frequency of transmission. The signal is then sent through a PA 1019 to increase the signal to an appropriate power level. In practical systems, the PA 1019 acts as a variable gain amplifier whose gain is controlled by the DSP 1005 from information received from a network base station. The signal is then filtered within the duplexer 1021 and optionally sent to an antenna coupler 1035 to match impedances to provide maximum power transfer. Finally, the signal is transmitted via antenna 1017 to a local base station. An automatic gain control (AGC) can be supplied to control the gain of the final stages of the receiver. The signals may be forwarded from there to a remote telephone which may be another cellular telephone, any other mobile phone or a land-line connected to a Public Switched Telephone Network (PSTN), or other telephony networks.

Voice signals transmitted to the mobile terminal 1001 are received via antenna 1017 and immediately amplified by a low noise amplifier (LNA) 1037. A down-converter 1039 lowers the carrier frequency while the demodulator 1041 strips away the RF leaving only a digital bit stream. The signal then goes through the equalizer 1025 and is processed by the DSP 1005. A Digital to Analog Converter (DAC) 1043 converts the signal and the resulting output is transmitted to the user through the speaker 1045, all under control of a Main Control Unit (MCU) 1003 which can be implemented as a Central Processing Unit (CPU).

The MCU 1003 receives various signals including input signals from the keyboard 1047. The keyboard 1047 and/or the MCU 1003 in combination with other user input components (e.g., the microphone 1011) comprise a user interface circuitry for managing user input. The MCU 1003 runs a user interface software to facilitate user control of at least some functions of the mobile terminal 1001 to provide edge-based interoperability of data and computations. The MCU 1003 also delivers a display command and a switch command to the display 1007 and to the speech output switching controller, respectively. Further, the MCU 1003 exchanges information with the DSP 1005 and can access an optionally incorporated SIM card 1049 and a memory 1051. In addition, the MCU 1003 executes various control functions required of the terminal. The DSP 1005 may, depending upon the implementation, perform any of a variety of conventional digital processing functions on the voice signals. Additionally, DSP 1005 determines the background noise level of the local environment from the signals detected by microphone 1011 and sets the gain of microphone 1011 to a level selected to compensate for the natural tendency of the user of the mobile terminal 1001.

The CODEC 1013 includes the ADC 1023 and DAC 1043. The memory 1051 stores various data including call incoming tone data and is capable of storing other data including music data received via, e.g., the global Internet. The software module could reside in RAM memory, flash memory, registers, or any other form of writable storage medium known in the art. The memory device 1051 may be, but not limited to, a single memory, CD, DVD, ROM, RAM, EEPROM, optical storage, magnetic disk storage, flash memory storage, or any other non-volatile storage medium capable of storing digital data.

An optionally incorporated SIM card 1049 carries, for instance, important information, such as the cellular phone number, the carrier supplying service, subscription details, and security information. The SIM card 1049 serves primarily to identify the mobile terminal 1001 on a radio network. The card 1049 also contains a memory for storing a personal telephone number registry, text messages, and user specific mobile terminal settings.

While the invention has been described in connection with a number of embodiments and implementations, the invention is not so limited but covers various obvious modifications and equivalent arrangements, which fall within the purview of the appended claims. Although features of the invention are expressed in certain combinations among the claims, it is contemplated that these features can be arranged in any combination and order.

1. A method comprising facilitating a processing of and/or processing (1) data and/or (2) information and/or (3) at least one signal, the (1) data and/or (2) information and/or (3) at least one signal based, at least in part, on the following:
a colocation one or more data records with one or more computations as one or more computation closures, wherein the one or more computations are for processing the one the one or more data records; and
a storage of the one or more computation closures at one or more nodes of at least one cloud computing architecture for servicing one or more queries, wherein the one or more nodes include, at least in part, one or more edge nodes, one or more regional nodes, one or more core nodes, or a combination thereof.

2. A method of claim 1, wherein the one or more edge nodes represent one or more boundaries between one or more domains of the at least one cloud computing architecture.

3. A method of claim 2, wherein the (1) data and/or (2) information and/or (3) at least one signal are further based, at least in part, on the following:
at least one determination of an exposure of one or more results of the one or more computation closures, the one or more data records, the one or more computations, or a combination in response to the one or more queries based, at least in part, on one or more privacy policies.

4. A method of claim 3, wherein the (1) data and/or (2) information and/or (3) at least one signal are further based, at least in part, on the following:
a limitation of the exposure to the one or more results of the one or more computation closures.

5. A method of claim 4, wherein the limitation is based, at least in part, on (a) the one or more privacy policies, (b) whether the one or more queries cross the one or more boundaries between the one or more domains, or (c) a combination thereof.

6. A method of claim 1, wherein the (1) data and/or (2) information and/or (3) at least one signal are further based, at least in part, on the following:
a migration of the one or more computation closures, the one or more data records, the one or more computations, or a combination thereof among the one or more nodes based, at least in part, on resource load information, resource availability information, or a combination thereof associated with the at least one cloud computing architecture.

7. A method of claim 6, wherein the migration causes the (1) data and/or (2) information and/or (3) at least one signal to be further based, at least in part, on the following:
a caching of the one or more computation closures, the one or more data records, the one or more computations, or a combination thereof at the one or more edge nodes, the one or more regional nodes, the one or more core nodes, or a combination thereof; and
a determination of one or more results of the one or more queries based, at least in part, on the caching.

8. A method of claim 6, wherein the migration causes the (1) data and/or (2) information and/or (3) at least one signal to be further based, at least in part, on the following:
a spawning of the one or more computation closures, the one or more data records, the one or more computations, or a combination thereof across the one or more boundaries of the one or more domains.

9. A method of claim 8, wherein the spawning is facilitated via one or more application interfaces at the one or more boundaries.

10. A method of claim 6, wherein the migration causes the (1) data and/or (2) information and/or (3) at least one signal to be further based, at least in part, on the following:
a prioritization of the migration of the one or more data records and the one or more computations to the one or more edges,
wherein the prioritization facilitates, at least in part, the servicing of the one or more queries at the one or more edge nodes.

11. An apparatus comprising:
at least one processor; and
at least one memory including computer program code for one or more programs,
the at least one memory and the computer program code configured to, with the at least one processor, cause the apparatus to perform at least the following,
cause, at least in part, a colocation one or more data records with one or more computations as one or more computation closures, wherein the one or more computations are for processing the one the one or more data records; and
cause, at least in part, a storage of the one or more computation closures at one or more nodes of at least one cloud computing architecture for servicing one or more queries, wherein the one or more nodes include, at least in part, one or more edge nodes, one or more regional nodes, one or more core nodes, or a combination thereof.

12. An apparatus of claim 11, wherein the one or more edge nodes represent one or more boundaries between one or more domains of the at least one cloud computing architecture.

13. An apparatus of claim 12, wherein the apparatus is further caused to:
determine an exposure of one or more results of the one or more computation closures, the one or more data records, the one or more computations, or a combination in response to the one or more queries based, at least in part, on one or more privacy policies.

14. An apparatus of claim 13, wherein the apparatus is further caused to:
cause, at least in part, a limitation of the exposure to the one or more results of the one or more computation closures.

15. An apparatus of claim 14, wherein the limitation is based, at least in part, on (a) the one or more privacy policies, (b) whether the one or more queries cross the one or more boundaries between the one or more domains, or (c) a combination thereof.

16. An apparatus of claim 11, wherein the apparatus is further caused to:
cause, at least in part, a migration of the one or more computation closures, the one or more data records, the one or more computations, or a combination thereof among the one or more nodes based, at least in part, on resource load information, resource availability information, or a combination thereof associated with the at least one cloud computing architecture.

17. An apparatus of claim 16, wherein the migration further causes the apparatus to:
cause, at least in part, a caching of the one or more computation closures, the one or more data records, the one or more computations, or a combination thereof at the one or more edge nodes, the one or more regional nodes, the one or more core nodes, or a combination thereof; and
cause, at least in part, a determination of one or more results of the one or more queries based, at least in part, on the caching.

18. An apparatus of claim 16, wherein the migration further causes the apparatus to:
cause, at least in part, a spawning of the one or more computation closures, the one or more data records, the one or more computations, or a combination thereof across the one or more boundaries of the one or more domains.

19. An apparatus of claim 18, wherein the spawning is facilitated via one or more application interfaces at the one or more boundaries.

20. An apparatus of claim 16, wherein the migration further causes the apparatus to:
cause, at least in part, a prioritization of the migration of the one or more data records and the one or more computations to the one or more edges,
wherein the prioritization facilitates, at least in part, the servicing of the one or more queries at the one or more edge nodes.

21-49. (canceled)
